(19) United States
(12) Patent Application Publication
(10) Pub. No.: US 2004/0258870 A1
(43) Pub. Date: Dec. 23, 2004

(54) Re-configurable modular floor covering

(76) Inventors: David D. Oakey, LaGrange, GA (US); Keith N. Gray, Marietta, GA (US); Graham A. H. Scott, LaGrange, GA (US); John Bradford, LaGrange, GA (US)

Correspondence Address: JOHN S. PRATT, ESQ, KILPATRICK STOCKTON, LLP, 1100 PEACHTREE STREET, ATLANTA, GA, 30309, US

(21) Appl. No.: 10/638,878

(22) Filed: Aug. 11, 2003

Related U.S. Application Data
(63) Continuation-in-part of application No. 10/381,025, filed on Dec. 8, 2003.
(60) Provisional application No. 60/403,790, filed on Aug. 15, 2002.

(51) Int. Cl. B32B 3/02; B32B 33/00; B32B 3/10

(52) U.S. Cl. 428/62; 428/45; 428/52; 428/82; 428/95

(57) ABSTRACT

A re-configurable floor covering and method of assembly that includes modular units that may be easily assembled in a variety of designs and that may be easily disassembled. This modular design provides flexibility in use and maintenance, as well as in removal and re-use. The modular units may be assembled so that adjacent units are linked.

### RELATED APPLICATION DATA

This application claims priority to U.S. Provisional Patent Application No. 60/403,790, filed Aug. 15, 2002, and is a continuation-in-part of U.S. patent application Ser. No. 10/381,025, filed Mar. 19, 2003, both of which are incorporated herein by reference in their entirety.

### FIELD OF THE INVENTION

This invention relates to floor coverings, including kits for purchaser assembly of such floor covering using modular textile face floor covering materials.

### BACKGROUND

Floor coverings have been in use since before recorded human history. The first such materials were undoubtedly animal skins. Later, floor coverings were manufactured, such as by weaving or knotting a variety of naturally occurring fibers including sisal and wool. Beginning in the twentieth century, such fiber-faced floor coverings began to be manufactured from man-made fibers as well.

While the first floor coverings were limited in size to the size of an animal skin, later floor coverings expanded to cover entire room floors. Such “wall-to-wall” installations of “broadloom” floor covering came into wide-spread use in the twentieth century. Paradigm installations of such materials utilize one or a small number of pieces of broadloom carpeting to cover entire room floors. This type of wall-to-wall floor covering is generally attached to the floor in some manner.

Later, modular floor coverings utilized smaller, uniform size modules or tiles in both solid surface floor coverings such as vinyl tiles and in textile-faced floor coverings, usually called carpet tiles. These tiles are generally installed so that they are attached to the floor in some manner. The standard against which such modular carpet installations was tested was the appearance of broadloom wall-to-wall installations, with the result that substantial effort was devoted to development of modules that would not be readily recognized as such in finished installations. Meanwhile, rugs continued to be widely used for all of the reasons for their historic popularity, importantly including decorative purposes.

While it became conventional to utilize more than one rug in a room, rugs have heretofore been manufactured as one piece structures that maintain the same appearance from manufacture through installation, except for a few instances where manufacturing practicalities dictated that an extremely large rug be assembled from smaller components in its place of use. Thus, throughout their history, rugs have been manufactured to have a particular appearance that cannot easily be changed by the user.

Conventional manufacture and packaging of conventional commercial carpet tile, a web of carpet tile face cloth and backing structure is manufactured, typically in a multiple of the finished tile width, such as four times as wide as a finished tile. The same top surface appearance is usually produced across the entire web. The finished web is typically die-cut into tiles, often cutting eight or twelve tiles from the web at one time. After inspection, the tiles are boxed or loaded on a pallet, in either case packaging groups of identical or substantially identical tiles. Such packaging is usually done without regard for the sequence in which tiles come from the cutting station or their location in the web, except as may be dictated by convenience. For instance, where a web is divided into four tiles across its width, each of the two tiles on one side of the web may go to one packaging station while each of the two tiles on the other side of he web may go to another packaging station.

### SUMMARY OF INVENTION

This invention is a re-configurable modular floor covering that includes modular units that may be easily assembled in a variety of designs and that may be easily disassembled. This modular design provides flexibility in use and maintenance, as well as in removal and re-use. The modular units may be assembled to form a floor covering without attaching the modules to a floor surface. Rather, individual units may be linked only to each other to form the floor covering, such as an area rug. The modules may also include a non-skid material on the underside of the module to reduce movement. Alternatively, the modules may be attached to an underlayment that is not attached to the floor surface. Finally, the modules may be assembled with a frame but not attached to the floor.

This re-configurable floor covering may be manufactured and delivered to the purchaser in modular units that can be assembled in more than one configuration, in accordance with instructions provided with the modular units, to provide a floor covering that can assume more than one appearance and shape. This enables manufacture of a product usable by a purchaser in more than one configuration, thereby, in effect, efficiently offering the marketplace multiple products. Importantly, a purchaser's initial choice of configuration can be changed, permitting the purchaser to change the appearance and or size of the floor covering of this invention in response to the purchaser's needs. Such needs may change, for instance, if a rug is used in different locations or with different furniture configurations or in response to a purchaser's simple desire for change in the appearance of the rug.

A modular floor covering of this invention differs significantly from existing installations of modular tiles in that the individual modular units are not attached to the floor, and are removably attached to each other to form the floor covering. A modular area rug of this invention also differs significantly from existing installations of carpet tile in that the edges of the rug normally do not abut baseboards or other room structures that hide and protect the edges, as is the case in installations of carpet tile, although the rug of this invention may occasionally be installed against one baseboard simply because that is the desire of the purchaser.

### BRIEF DESCRIPTION OF THE DRAWINGS

FIGS. 1-13 illustrate various floor covering designs using a re-configurable floor covering kit including three different types of modular units.

### DETAILED DESCRIPTION

The re-configurable floor covering of this invention includes modular units that combine to form a floor covering. The modular units may be of various color and texture palettes in a range of sizes and shapes. For example, individual modules may be in a shape that simulates wood planking or in any shape currently available as a ceramic, including, but not limited to squares, rectangles, triangles and other shapes. In addition, the modules may be provided in a variety of textures. Modular units of this invention may typically be conventional carpet tile, but could also be other modular materials, including woven textile flooring, solid vinyl, ceramics, leather, or any other suitable material. This re-configurable floor covering may be used on a generally smooth surface, including, but not limited to plywood, laminates, linoleum, vinyl tile, hardwoods, and concrete.

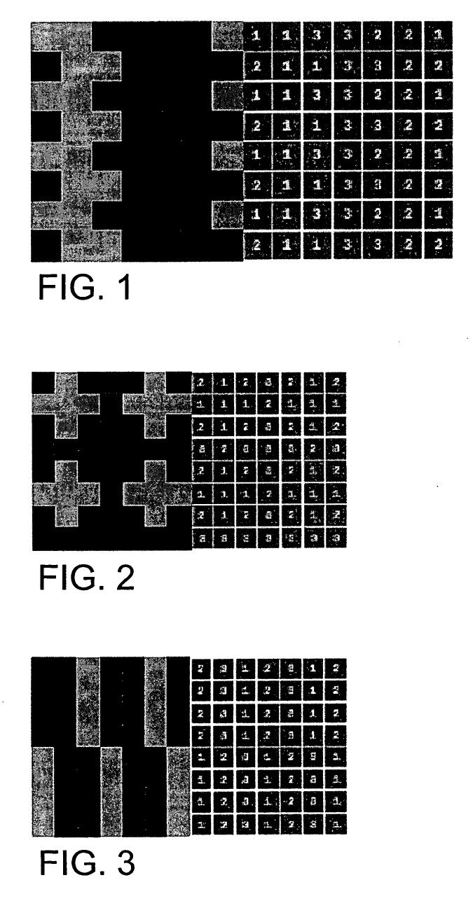

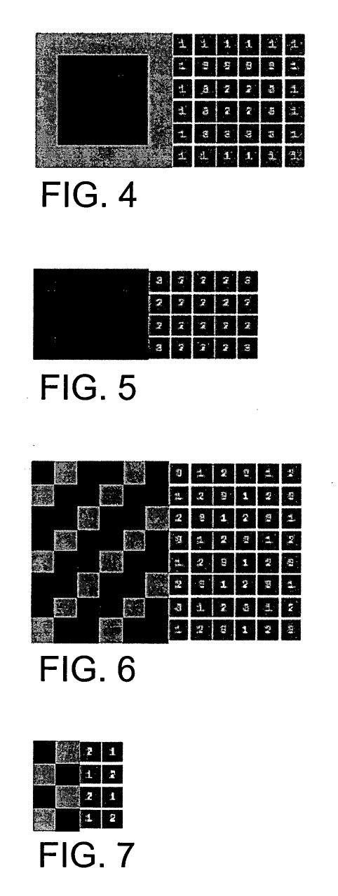

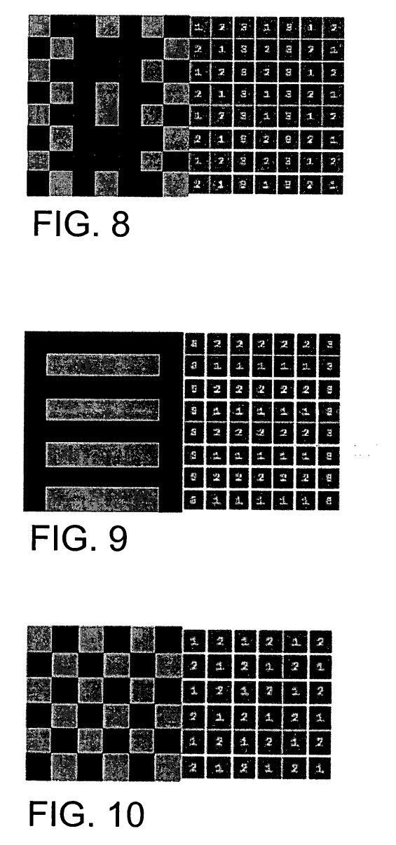

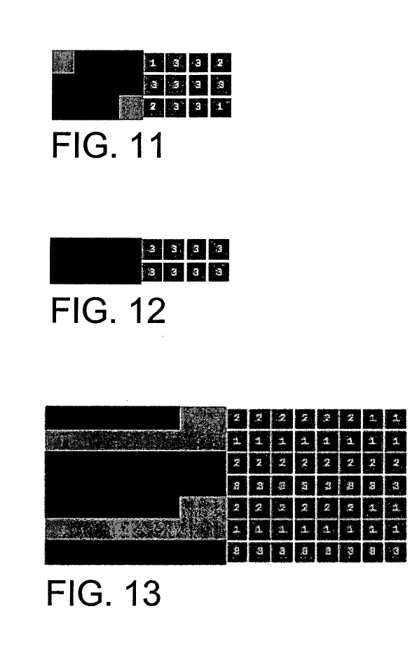

Designs may be reconfigured in a variety of patterns, from common designs to designs unique to the purchaser. One example of a set of re-configuration options for a re-configurable modular floor covering with three different types of modular units is illustrated in FIGS. 1-13. The kit in this example provides 30 units of modular unit 1, 30 units of modular unit 2, and 16 units of modular unit 3, for a total of 56 modular units. The modular units, 1, 2 and 3, may be arranged in a variety of designs and patterns, using all or part of the units provided.

This re-configurable floor covering utilizes modular units having face colors and patterns selected for use in, and usable in, multiple patterns obtained by different configurations of the modules. Such patterns are depicted in instructions accompanying a kit of this invention and maybe depicted on the packaging or in other printed materials utilized at the point of purchase or otherwise, such as on the Internet, to communicate to potential purchasers the different configurations that are possible utilizing a particular kit.

While the floor covering modules are generally of relatively substantial size and weight, which facilitates maintenance of the modules in the positions they are placed when the floor covering is assembled, it is desirable to provide a means for further resisting module movement. This may be accomplished by placing adhesive on the underside of the modules. Such adhesive should have the ability to maintain the module's position during normal use but should not be so aggressive that it is difficult to remove a module in order to reposition it. There also should be little or no residue of adhesive on the surface on which the module rested after it is removed. If any residue does remain, it should be easily removable without damage to the underlying floor surface. These adhesive attributes can be provided by utilizing pressure sensitive adhesive applied, for instance, in a relatively narrow strip across each module underside and covered, prior to module installation, by a plastic film or paper strip that is peeled off just before module placement. Pressure sensitive adhesive buttons may also be applied to the underside of a module and covered. For example, buttons having a diameter of approximately 1.25 inches may be applied in each corner of a square-shaped module. The adhesive may be low-tack, so that the modules may be easily repositioned. In addition, the modules may be manufactured from materials in a manner so that they tend to “hug” the floor surface. This allows only key modules, such as perimeter squares on an area rug, be adhered to the floor.

Alternatively, it may be desirable to assemble a floor covering without the need to attach the floor covering to the underlying floor surface, so that the modular floor covering “floats” on the underlying floor surface. Such a floor covering may be assembled by the purchaser and end-user and would not really be conventionally “installed” to the extent that it is not attached to the floor, e.g. the modules are not glued to the floor. However, it is necessary to provide resistance to module movement. Resistance to module movement may be provided by linking the modules together to form a floor covering, so that the modular units are linked to one another, but not to the floor surface. In this manner, the weight of the entire rug fixes the assembled rug to the floor. Such linking of the modules may be accomplished using vinyl one-sided adhesive tape to secure the modules to each other. For example, one-sided tape approximately the size and thickness of a standard business card may be used to link modules. Alternatively, the modules may be linked using hook and loop type fasteners, magnets or magnetized material, adhesives, or other chemical bonding, such as epoxy, or any other suitable link.

Alternatively, underlayment the size of the desired floor covering may be used, so that the modules are attached to the underlayment, but the underlayment is not attached to the floor. The underlayment may be plastic film, a foam pad such as latex or polyurethane foam (with or without additional layers such as woven polypropylene or fiberglass mat). Any other suitable materials could also be used, such as a woven, knitted or non-woven textile fabric. Finally, the modules may be assembled using a frame, eliminated the need to attach the modules to the floor surface.

All of the components and the instructions for assembly of a floor covering of this invention may be packaged together so that everything needed by a purchaser can be easily obtained at one time and without the need to confirm the compatibility of, or the need to select, multiple components.

The modular units of this re-configurable floor covering may be assembled in a variety of designs and may be easily disassembled. Thus, the modular design provides flexibility in use and maintenance, as well as in removal and re-use. For example, individual modules may be removed and replaced as required. Modules of the re-configurable floor covering kit of this invention may be washable, and may include antimicrobial agents. The modules may also be moved in order to vary the style of the rug. This re-configurable floor covering is therefore easy to install, use, manipulate, move, clean and store. In addition, modules of this rug may be recycled, and may be retrievable by the manufacturer.

Re-configurable floor covering of this invention may utilize conventional commercial free-lay carpet tiles of the type manufactured for wall-to-wall installation. Some of such tiles have attributes enhancing their attractiveness for use in practicing this invention. For instance, modules having relatively thin backing structures and/or relatively thin face structures may be attractive so that the floor covering of this invention has a low profile on the floor where it is located. In other instances, thicker backing structures, or face structures, or both may be desired for aesthetic or other reasons.

Edge treatments are not required to maintain the structural integrity of a module of this invention. The module will not unravel if the edge is untreated. While the appearance of the “unfinished” edges of the floor covering of this invention likely would have been unacceptable during at least some prior times, “techno” and other current styles frequently display as a design feature, rather than hide, such elements of building structure and room furnishings. In this environment, an edge appearance of the floor covering of this invention clearly displaying the top-to-bottom floor covering structure is acceptable.

In addition, modules having particular edge treatments may also be desirable for use in practicing this invention. For instance, it may be desirable to remove a portion of the face fibers along a sloping plane at the module edge in order to visually and physically reduce the edge profile for aesthetic reasons as well as functional ones. A portion of the face fibers can be removed along a sloping plane at the module edge in order to form a visibly and physically smaller edge profile so that edges of the floor covering will visually taper down to the underlying floor surface and wheel or foot traffic will easily transition from the underlying floor surface to the rug. Such beveled edge treatment can be applied solely to the edges of modules that will form an assembled edge (i.e., on two adjacent edges of modules that will form the corners as assembled and on one edge of modules that will have that edge positioned at the perimeter of the floor covering). Alternatively, all edges of all modules can be so treated even though the presence of such treatment will be visually prominent within the interior of the assembled floor covering, since such edge treatment can be an aesthetically attractive design feature of the interior of the floor covering just as it is at the perimeter of the assembled floor covering.

Production of the re-configurable modular floor covering kits of this invention may require manufacturing and packaging techniques that differ from conventional techniques and practices. In one alternative for producing the floor covering modules to be used in this invention, relatively substantial numbers of each type of module needed for a particular kit or for all of the kits to be offered are manufactured sequentially, and each type of module is “stockpiled” in a storage facility. After a stockpile of each needed type of module has been produced, the number of each type of module needed for a particular kit are withdrawn from the stockpile and packaged together. The stockpiles may include more module types than are used in any one kit. Using this technique, kits can be packaged in advance of sale, or can be packaged only after selection of a particular kit by a purchaser. The latter approach permits the kit manufacturer economically to offer a larger number of kits because specific kits do not have to be packaged and warehoused before purchase. Indeed, if kits are not packaged until they have been ordered by a purchaser, it is possible to enable to purchaser to design her own re-configurable modular floor covering kit, by choosing her own combination of modules from those that the kit manufacturer has available. Such a process can be relatively easily implemented over the Internet by providing a web site having functionality that permits a purchaser to select particular modules for inclusion in her own kit, including permitting the purchaser to “see” the finished kit in the form of a computer generated display. For instance, a “rug kit template” can be displayed showing the module positions in a particular rug kit size and shape, and the purchaser can “fill in the blanks” by indicating the type of module that she desires to show in each blank.

In another alternative, kits of this invention may be produced by manufacturing a carpet tile web that has present on the same web the different module designs that are to be supplied in a particular kit. Those different designs are cut from the web using techniques that result in module-dividing cuts in proper registration with the designs. As a result, all of the different modules needed for inclusion in a particular kit will come off of the assembly line relatively contemporaneously. Those modules are immediately packaged together, and the packaged kits can then be stored or sent to purchasers as appropriate.

The embodiment described above is illustrative and non-limiting. Many variations of the structures illustrated in the drawings and the materials described above are possible and within the scope of this invention as defined in the claims.

1. A method of assembling carpet tile modules, comprising:
(a) selecting carpet tile modules for creating a floor covering having a first design;
(b) arranging the modules on the floor, each module abutting at least two other modules, creating the first design;
(d) removing the modules;
(e) selecting a second design;
(f) arranging the modules on the floor, each module abutting at least two other modules, creating the second design.

2. The method of claim 1, further comprising creating a second design using the selected modules and additional modules.

3. The method of claim 1, further comprising creating a third design using the selected modules.

4. The method of claim 1, further comprising creating a second design using fewer than all of the selected modules and no additional modules.

5. The method of claim 1, wherein at least two adjacent modules are linked.

6. The method of claim 5, further comprising adhesive for linking at least two adjacent modules.

7. The method of claim 6, wherein the adhesive comprises one-sided tape.

8. The method of claim 5, further comprising a hook and loop structure for linking at least two adjacent modules to each other.

9. The method of claim 5, further comprising at least one magnet for linking at least two adjacent modules.

10. The method of claim 5, further comprising a chemical bond for linking at least two adjacent modules.

11. The method of claim 1, further comprising adhesive for attaching at least modules on the perimeter of the floor covering to the floor.

12. A method of assembling floor covering modules, comprising:
(a) selecting a kit comprising modular units,
(b) arranging the modular units on the floor, each modular unit adjacent to at least two other modular units, and
(c) linking at least two adjacent modular units so that the floor covering floats directly on the underlying floor surface.

13. The method of claim 12, further comprising disassembling the floor covering and assembling the modular units in a second design.

14. The method of claim 12, further comprising adhesive for linking at least two adjacent modular units.

15. The method of claim 14, wherein the adhesive comprises one-sided tape.

16. The method of claim 12, further comprising a hook and loop structure for linking at least two adjacent modular units.

17. The method of claim 12, further comprising at least one magnet for linking at least two adjacent modular units.

18. The method of claim 12, further comprising a chemical bond for linking at least two adjacent modular units.

19. The method of claim 12 wherein the floor covering is an area rug.

20. The method of claim 12 wherein the floor covering is a wall-to-wall floor covering.

21. A method of merchandising re-configurable modular floor covering, comprising:
(a) creating multiple floor covering designs;
(b) producing modular units adapted to be linked to each other and adapted to float directly on the underlying floor surface;
(c) warehousing the modular units;
(d) selecting the modular units required for a set of floor covering designs;
(e) packaging a kit comprising the modular units for the set of designs and instructions for assembly; and
(f) delivering the kit to a purchaser or retailer.

22. The method of claim 21, further comprising:
(g) assembling the modular units into a floor covering, comprising arranging the modular units on the floor, each modular unit adjacent to at least two other modular units.

23. The method of claim 22 further comprising:
(h) linking adjacent modular units so that the floor covering floats on the underlying floor surface.

24. The method of claim 22, further comprising disassembling the floor covering and reassembling the floor covering in a different design.

25. The method of claim 21 wherein the floor covering is an area rug.

26. The method of claim 21 wherein the floor covering is a wall-to-wall floor covering.

27. A re-configurable rug kit, comprising:
(a) a plurality of carpet tile modules, each module adapted to be assembled as a rug in at least two rug designs and adapted to be easily altered between the at least two designs; and
(b) instructions for installation of the at least two designs.

28. The kit claim 27, wherein at least two adjacent modules are linked and wherein the modules are not attached to the floor surface.

29. The kit of claim 27, wherein the modules comprise adhesive.

30. The kit of claim 27, wherein at least the perimeter modules are removably attached to the floor surface.

31. An area rug comprising
(a) modular units adapted to be linked to each other and not attached to the floor surface; and
(b) connectors for linking adjacent units wherein the connectors have a combined surface area smaller than the surface area of the rug.

32. The area rug of claim 31 further comprising one-sided tape for linking the modules.

33. The area rug of claim 31 further comprising hook and loop structure for linking the modules.

34. The area rug of claim 31 further comprising at least one magnet for linking the modules.

35. The area rug of claim 31 further comprising a chemical bond for linking the modules.

36. The area rug of claim 31 further comprising a frame adapted to enclose the perimeter of the assembled rug.

37. The area rug of claim 31 wherein the modular units further comprise a non-skid component.

38. A floor covering comprising
(a) a plurality of modules adapted to float directly on the floor, and
(b) adhesive for linking modules to each other.

39. The area rug of claim 31 wherein the connectors have a combined surface area of about 0.60 percent to about 5 percent of the surface area of the rug.
